(19) United States
(12) Patent Application Publication
(10) Pub. No.: US 2024/0352556 A1
(43) Pub. Date: Oct. 24, 2024

(54) METHOD FOR SUSTAINABLY RECYCLING ALUMINIUM ALLOY SCRAP

(71) Applicants: CONSTELLIUM ISSOIRE, Issoire (FR); CONSTELLIUM NEUF-BRISACH, Biesheim (FR); CONSTELLIUM MUSCLE SHOALS LLC, Muscle Shoals, AL (US)

(72) Inventors: Anne PICHAT, Saint-Cassien (FR); Marc BERTHERAT, Veyras (CH); Alain VASSEL, Saint Etienne de Crossey (FR)

(73) Assignees: CONSTELLIUM ISSOIRE, Issoire (FR); CONSTELLIUM NEUF-BRISACH, Biesheim (FR); CONSTELLIUM MUSCLE SHOALS LLC, Muscle Shoals, AL (US)

(21) Appl. No.: 18/683,671

(22) PCT Filed: Aug. 29, 2022
(86) PCT No.: PCT/FR2022/051619

§ 371 Date: Feb. 14, 2024

(30) Foreign Application Priority Data
Aug. 31, 2021 (FR) FR2109085

(51) Int. Cl. C22B 21/00; C22B 7/00; C22B 9/00; C22B 9/05; C22B 9/16

(52) U.S. Cl. CPC C22B 21/0092; C22B 7/003; C22B 9/003; C22B 9/006; C22B 9/05; C22B 9/16; C22B 21/0007

(57) ABSTRACT

The invention relates to a method for re-melting coated aluminum alloy scrap comprising a step of supplying shredded coated aluminum alloy scrap, consisting of individual entities; a decoating step, a step of preparing a heel, a step of loading and melting the decoated scrap on the heel. The invention is characterized in that the scrap has a specific geometry wherein at least 50% of the individual entities of the shredded coated scrap has a fold ratio (R) of less than or equal to 0.6, wherein the fold ratio (R) of an individual entity is defined by: fold ratio=R=(unfolded area−folded area)/(unfolded area), wherein the folded area is the maximum area of the orthogonal projection of the individual entity onto a plane and the unfolded area is the total area of the same individual entity after it has been unfolded.

### TECHNICAL FIELD

The invention relates to the re-melting in an induction furnace of coated aluminum alloy scrap, preferably scrap recovered from aluminum household packaging, typically used aluminum beverage cans.

### PRIOR ART

Recycling aluminum has the advantage of being economical and ecological. The production of secondary aluminum requires up to 95% less energy than primary aluminum and allows the reduction of CO₂ emissions. In order to improve the environmental impact of aluminum production, the aluminum industry seeks to reduce the amount of CO₂ emitted during the recycling step during the scrap re-melting step.

In this text, the generic formula “scrap” refers to raw materials for recycling, consisting of aluminum and/or aluminum alloy products resulting from the collection and/or recovery of metals produced at different manufacturing steps or products after use. Unless otherwise stated, reference is made to standard NF EN 12258-3 Sep. 2003 which defines terms relating to aluminum and aluminum alloy scraps. “Coated scrap” is scrap composed of parts having any type of coating, for example paint, varnish, printing ink, plastic, paper, metal.

Aluminum alloy beverage cans consist of a can body and a lid; usually the can body is made of AA3104 alloy and the lid of AA5182 alloy. The can body and the lid are coated with an organic and/or inorganic coating such as a varnish and/or paint and/or organic material.

Used beverage cans, also called UBC (Used Beverage Can) made of aluminum belong to the category of coated scrap. Likewise, food packaging or aerosol cans made of aluminum alloys belong to the category of coated scrap. They are contaminated by the presence of varnish and/or paint and/or printing ink generally. It is also possible that these containers are contaminated by the possible presence of dust, sand, water, beverage residues or other pollution.

Among household packaging, mention can be made of used beverage cans, used food packaging, used aerosol cans. These types of products or any other aluminum alloy coated products can be collected. Usually, after collection, these products are compacted to form “bales” or “briquettes” which facilitate storage and transport. Compaction is also sometimes considered to facilitate the submergence of scraps in re-melting furnaces as in application U.S. Pat. No. 4,159,907.

However, it is also possible to shred them. Scrap in divided form, consisting of individual entities is obtained. The grinding operation allows in particular to shred the products and prevent liquid from being still present in the containers and thus avoid the risk of explosion during the re-melting operation. It is possible during this grinding step to carry out sorting to separate any contamination such as possible pieces of scrap metal, any other metal products not being made of aluminum or aluminum alloy or plastic products.

The technology used in the profession for the recycling of coated products, in particular UBC, usually uses a dedicated line made up of cold preparation steps (mill, magnetic sorting and air blade separator), hot elimination in a “decoater” of inks, varnishes and other organic materials. The coated scraps are then typically re-melted in a side-well furnace. Treatment of the metal by adding salt (3% to 5%) is necessary to eliminate the oxides contained in the liquid metal (R. Evans, G. Guest, “The aluminum decoating handbook”, Stein Atkinston Stordy, Gillespie Powers internet source). The metal is then transported to the foundry workshop to be cast. Another alternative is to carry out re-melting in a rotary furnace. This solution requires a higher salt level than for the side-well furnace (10% to 15%). In this case, the combustion of the organic materials and the re-melting of the metal take place simultaneously within the furnace enclosure.

U.S. Pat. No. 3,999,980 describes a method not requiring prior treatment in a UBC “decoater”. It is carried out in a scrap melting furnace under an inert atmosphere and compares it to typical methods using molten salt.

Another alternative is re-melting in a multi-chamber furnace (“Aluminum recycling” M. Schlesinger, CRC Press, (2007)). The coated scraps are loaded, preheated and decoated in a separate chamber (vertical tunnel or horizontal ramp). The combustion of organic materials helps heat the installation. It is a salt-free method. This solution has the disadvantage of having to be carried out in a gas furnace, which is not adapted for reducing CO₂ emissions.

A solution for reducing CO₂ emissions is to use electric furnaces. Induction furnace technology is mentioned for UBC recycling in reference works (R. Evans, G. Guest, “The aluminium decoating handbook”, Stein Atkinston Stordy, Gillespie Powers internet source). The electric crucible induction furnace has the advantage of good energy efficiency and generates little metal loss. The large capacity electric channel furnace is sometimes used for the re-melting of new manufacturing scraps or beverage cans after decoating (F. Herbulot-Récupération et recyclage de l'aluminium—Techniques de l'Ingénieur—March 2001). However, these types of furnaces have not experienced significant industrial growth. They require clean raw materials to avoid progressive clogging of the crucible walls by oxides or the formation of oxides in the metal.

However, with regard to the treatment of coated scrap in an induction furnace, there is a prejudice among the person skilled in the art indicating that the recycling of coated scrap, in particular scrap recovered from used beverage cans, is not possible in an electric induction furnace on an industrial scale without the use of molten salts (Verran and al. Resources, Conservation and Recycling 52 (2008) 731-736). The molten salts act as an oxide collector and create a pasty saline slag which separates from the liquid metal and floats thereon. The presence of saline slag has the disadvantage of reducing the gross or net metal yield. “Gross metal yield” (expressed in %) is the ratio between the mass of liquid metal actually discharged or cast to the mass of material loaded into a furnace. “Net metal yield” is the ratio between the mass of liquid metal actually discharged or cast to the net mass of metal loaded into a furnace.

There is therefore a need for an economical and reliable solution allowing the use of induction furnaces without molten salts in the treatment of coated scrap, in particular scrap recovered from used aluminum beverage cans.

US2020/0255922 describes a treatment method in a vacuum induction furnace for recycling lithium aluminum alloy machining scrap. This method is carried out in batch, that is to say that the lithium aluminum alloy scrap is put into the furnace all at once to ensure vacuum operation. In order to increase the amount of molten metal in the furnace, US2020/0255922 provides a chip compaction step.

WO 2007/015013 describes a treatment method in an induction furnace for recycling lithium aluminum alloy machining scrap. The lithium aluminum alloy scraps are loaded on a liquid metal heel so as to create a floating mattress of scrap of controlled thickness on the surface of the liquid metal bed (loading step). This floating scrap mattress protects the liquid metal from oxidation and avoids the use of an inert atmosphere. This floating mattress is made up of divided scraps of which at least one dimension is less than 1 mm and for which no dimension is greater than 25 mm. The volumetric mass of the scrap is comprised between 0.05 and preferably 0.1 to 0.7 t/m³ (ton per cubic meter) and even more advantageously between 0.2 to 0.4 t/m³. The inventors noted that it was not possible to obtain a good gross metal yield with coated scrap using these geometric considerations alone.

U.S. Pat. No. 4,159,907 shows the disadvantage of the low volumetric mass of the scrap which tends to remain on the surface of the liquid aluminum and to oxidize and proposes to densify the scrap by compression to solve this problem. Other documents in the prior art propose alternative solutions to the immersion of scrap in melting furnaces. U.S. Pat. No. 6,074,455 describes a method for rapidly immersing scrap in liquid aluminum thanks to its introduction into the vortex created by a rotor. U.S. Pat. No. 3,873,305 describes a method for melting beverage can scrap wherein the scrap is forced to be submerged by the action of a rotating propeller. JP 10147822 describes a furnace used for melting beverage can scrap wherein the scrap is mixed above the liquid metal bath using specific equipment. These immersion solutions using mechanical means to immerse the scraps have the disadvantage of promoting oxidation of the bath which is not favorable for the gross metal yield.

The problem that the present invention seeks to solve is therefore to propose a method for recycling coated aluminum alloy scrap, preferably scrap recovered from aluminum household packaging, typically used aluminum beverage cans, using an induction re-melting furnace without using protective salts.

### DESCRIPTION OF THE INVENTION

The object of the invention is a method for re-melting coated aluminum alloy scrap comprising the following steps
(i) aluminum alloy shredded coated scrap, consisting of individual entities, is supplied,
(ii) decoating of said shredded coated scrap is carried out to obtain decoated scrap,
(iii) an initial liquid metal heel of a first composition is prepared in a crucible induction furnace operating at a given frequency,
(iv) the decoated scrap is loaded in the induction furnace directly on the initial heel in order to be melted.

According to the invention, at least 50% of the individual entities of the shredded coated scrap supplied in step i) has a fold ratio (R) of less than or equal to 0.6,
wherein the fold ratio (R) of an individual entity is defined by

$$fold ratio = R = \frac{unfolded area - folded area}{unfolded area}$$

wherein the folded area is the maximum area of the orthogonal projection of the individual entity onto a plane and the unfolded area is the total area of the same individual entity after it has been unfolded.

Advantageously, the shredded coated scrap is obtained according to a method comprising a shredding step with a knife mill, preferably equipped with a grid. According to the invention, the knife mill used is preferred because it allows a clean cut and avoids “creasing” the scraps which leads to crippling folding to obtain effective decoating and introduction of the scraps into the crucible induction furnace. Preferably, before the step of supplying shredded coated scrap, coated scrap is supplied, then is ground in a knife mill. This involves cutting the coated scrap between knives mounted on a rotating shaft and a fixed row of knives. The presence of a grid can ensure particle size control at the outlet.

This preliminary grinding step in a knife mill corresponds to a method for re-melting coated aluminum alloy scrap comprising the following successive steps:
coated aluminum alloy scrap, preferably scrap recovered from aluminum household packaging, typically used aluminum beverage cans, is supplied
Said coated scrap is shredded in a knife mill, optionally provided with a grid, to obtain shredded coated scrap consisting of individual entities.
said shredded coated scrap is decoated to obtain decoated scrap,
an initial heel of liquid metal of a first composition is prepared in a crucible induction furnace operating at a given frequency,
the decoated scrap is loaded into the induction furnace directly on the initial heel in order to be melted.

According to the invention, at least 50% of the individual entities of the shredded coated scrap has a fold ratio (R) of less than or equal to 0.6,

wherein the fold ratio (R) of an individual entity is defined by

$$fold ratio = R = \frac{unfolded area - folded area}{unfolded area}$$

wherein the folded area is the maximum area of the orthogonal projection of the individual entity onto a plane and the unfolded area is the total area of the same individual entity after it has been unfolded.

Advantageously, at least 50% of the individual entities of the shredded coated scrap supplied in step i) has a particle size comprised between 5 and 50 mm, preferably between 8 and 50 mm, more preferably between 8 and 25 mm, more preferably between 8 and 16 mm, the particle size being measured by sieving.

According to this advantageous embodiment, the shredded coated scrap is obtained according to a method comprising a shredding step with a knife mill, equipped with a grid adapted to obtain a particle size comprised between 5 and 50 mm, preferably between 8 and 50 mm, even more preferably between 8 and 25 mm, even more preferably from 8 to 16 mm.

This preliminary grinding step in a knife mill equipped with a grid corresponds to a method for re-melting coated aluminum alloy scrap comprising the following successive steps:
coated aluminum alloy scrap, preferably scrap recovered from aluminum household packaging, typically used aluminum beverage cans, is supplied
Said coated scrap is shredded in a knife mill, provided with a grid, to obtain shredded coated scrap consisting of individual entities
said shredded coated scrap is decoated to obtain decoated scrap,
an initial heel of liquid metal of a first composition is prepared in a crucible induction furnace operating at a given frequency,
the decoated scrap is loaded into the induction furnace directly on the initial heel in order to be melted.

Advantageously, at least 50% of the individual entities of the shredded coated scrap supplied in step i) has a height of less than or equal to 50 mm, preferably less than or equal to 30 mm, even more preferably less than or equal to 15 mm.

Advantageously, the volumetric mass of the shredded coated scrap supplied in step i) is comprised between 0.2 and 0.4 t/m³.

Advantageously, the coated scrap supplied in step i) is mainly made up of scrap recovered from aluminum household packaging, typically used aluminum beverage cans.

That is to say that the shredded coated scrap is obtained from scrap recovered from aluminum household packaging, typically used aluminum beverage cans.

Advantageously, the decoated scrap obtained after step ii) is introduced into the induction furnace in step iv) at a temperature above 100° C., preferably at a temperature comprised between 200° C. and 450° C., more preferably between 300° C. and 450° C., even more preferably between 400° C. and 450° C.

Advantageously, no protective salt is used in the induction furnace.

Advantageously, during step iv) a floating decoated scrap bed is maintained on the surface of the liquid bath for most of the duration of step iv).

Advantageously, the frequency of the induction furnace during step iv) is comprised between 50 Hz and 150 Hz.

Advantageously, the loading in step iv) is carried out discontinuously or continuously, preferably using a worm or a hopper or a vibrator system.

Advantageously, the temperature of the liquid metal bath during step iv) is less than or equal to 750° C., preferably less than or equal to 730° C.

Advantageously, during step iv) the liquid metal bath is inerted, typically using a flow of argon gas.

### FIGURES

FIG. 1 shows the principles of the method for measuring the fold ratio R. 1a and 1c respectively show the appearance of an individual entity of supplied shredded coated scrap and the appearance of the same unfolded individual entity. 1 b shows the orthogonal projection of the individual entity 1a giving a maximum area. 1d shows the contour of the unfolded area allowing the measurement of the unfolded area.

FIG. 2 shows the method for measuring the height of an individual entity of shredded coated scrap.

FIG. 3 shows the appearance of the shredded coated scraps supplied according to the invention.

FIG. 4 shows a diagram of a crucible induction furnace with the stirring movements.

FIG. 5 shows the appearance of the shredded coated scrap outside the invention obtained by a hammer mill method.

### DETAILED DESCRIPTION OF THE INVENTION

The method according to the invention comprises four successive steps: firstly a step of supplying the shredded coated scrap, secondly a step of decoating the shredded coated scrap, thirdly a step of preparing a liquid metal heel in an induction furnace and fourthly loading the decoated scrap into the induction furnace.

### 1/ Supplying the Shredded Coated Scrap

The coated scrap capable of being recycled by the method according to the present invention is in shredded form. It is important according to the invention that the coated scrap is shredded and supplied in divided form. The shredded coated scrap according to the invention consists of individual entities. They are smaller in size compared to that of initial waste such as beverage cans or food cans.

In the following, unless otherwise stated, the proportions in % of individual entities correspond to numerical % of individual entities.

It is important according to the invention that the majority of the individual entities of the shredded coated scrap have a fold ratio of less than or equal to 0.6. Advantageously, at least 50% of the individual entities of the shredded coated scrap have a fold ratio (R) of less than or equal to 0.6. Preferably, at least 60%, or 70% or 80% of the individual entities of the shredded coated scrap have a fold ratio (R) of less than or equal to 0.6. The fold ratio of an individual entity is defined by equation 1.

$$fold ratio = R = \frac{unfolded area - folded area}{unfolded area} \qquad ( equation 1 )$$

Preferably, at least 50% of the individual entities of the shredded coated scrap supplied in step i) has a fold ratio (R) of less than or equal to 0.5, even more preferably less than or equal to 0.4. The fold ratio of an individual entity of the shredded coated scrap quantifies how that individual entity was folded in previous steps. The higher this ratio, the more the individual entity was folded and is therefore compact, particularly in globular form. The lower the ratio, the more planar the individual entity. The inventors found that it was necessary to have a fold ratio of less than or equal to 0.6 to avoid the use of salts, called recycling flow, to separate the oxides from the liquid metal, during the step of re-melting in the crucible induction furnace.

The folded area is the apparent area of an individual entity of shredded coated scrap. The folded area is defined as the maximum area of the orthogonal projection onto a plane of the individual entity.

The unfolded area corresponds to the developed area of an individual entity of shredded coated scrap. The unfolded area is defined as the total area of the individual entity of shredded coated scrap after it has been unfolded. It should be noted that knowing the thickness and the mass and the average volumetric mass of the individual entity the unfolded area can be easily determined. The unfolded area can also be obtained by unfolding the individual entity.

For example, if an individual entity of shredded coated scrap typically having the size of a postage stamp and having an unfolded area of 1 cm² is considered, it has a fold ratio of 0.5 if this entity is folded into two. This same entity has a fold ratio of 0 if it has not been folded.

The inventors have found that the number of folds or surface covering deteriorates the flatness of the individual entity. On the other hand, they noted that it is important that the coated scrap be folded on itself as little as possible so that the coated surfaces are in direct contact with the atmosphere of the decoating furnace and that consequently the mass and heat exchanges on the surface of the scrap occurring during the decoating operation can be done as efficiently as possible.

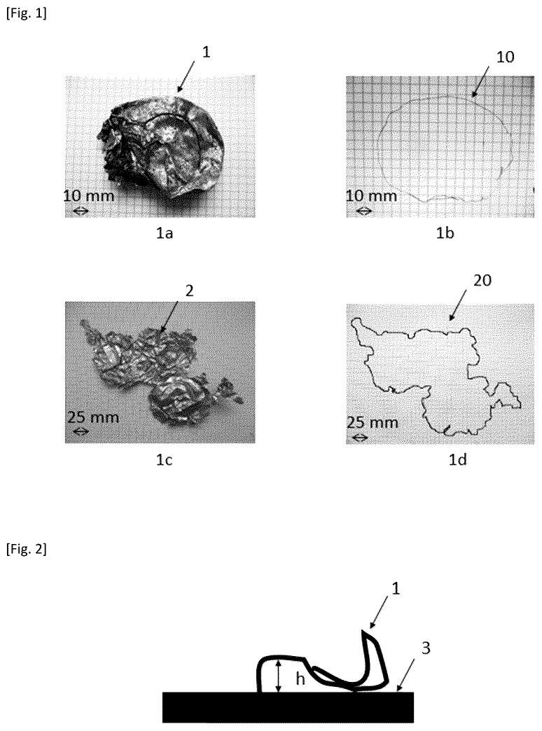

The fold ratio can be measured as follows: an individual entity of shredded coated scrap (1, FIG. 1a) is taken. A sheet of paper whose mass m₀ and surface S₀ are known is used. The outline of the individual entity is drawn on the sheet in such a way as to obtain the folded area (10, FIG. 1b), ensuring that the individual entity has been placed on the sheet of paper in such a way as to have the projection of the maximum area of the individual entity of coated scrap (10, FIG. 1b). Thus the maximum area of the orthogonal projection of the individual entity onto a plane is obtained. The outline is cut and the piece m₁ is weighed. Once this step is completed, the same individual entity of shredded coated scrap is unfolded (2, FIG. 1c). A sheet of paper whose mass m′₀ and its surface S′₀ are known is taken. The contours of the individual coated scrap entity thus unfolded (20, FIG. 1d) are drawn; the contours are cut and m₂ is weighed. The fold ratio (R) can be deduced according to equation 2

$$R = \frac{\frac{{m}_{2}}{{m}_{0}^{′}} {S}_{0}^{′} - \frac{{m}_{1}}{{m}_{0}} {S}_{0}}{\frac{{m}_{2}}{{m}_{0}^{′}} {S}_{0}^{′}} \qquad ( equation 2 )$$

The unfolding operation can be done manually. During this operation, pieces may come off. Each of the pieces must be taken into account when measuring the mass m₂.

The estimation of the percentage of individual entities of shredded coated scrap having a fold ratio of less than 0.6 can be carried out on the whole of the scrap or on a part, typically on a number of individual entities at least equal to 20.

Advantageously, the individual entity of shredded coated scrap is substantially planar. An individual entity of shredded coated scrap can fit into a fictitious volume defined by a length, width and height. The flatness of the individual entity of shredded coated scrap is characterized by the minimum height of the fictitious volume, expressed in mm. To measure the height (h), an individual entity of shredded coated scrap 1 is placed on a flatness ruler 3 so as to obtain the minimum height of the entity (see FIG. 2). The flatness ruler can be any flat surface, such as a measuring marble.

Advantageously at least 50% or 60% or 70% or 80% of the individual entities of the shredded coated scrap have a height of less than or equal to 50 mm, or 40 mm, or 30 mm, or 20 mm or 15 mm or 10 mm or 5 mm. The inventors have found that the height of an individual entity of shredded coated scrap is not modified by the decoating operation. The inventors believe that having a majority of individual entities of shredded coated scrap having a height of less than or equal to 50 mm, or 40 mm, or 30 mm, or 20 mm or 15 mm or 10 mm or 5 mm, favors their arrangement in the form of stacked strata and improves their submergence in the liquid metal bath of the induction furnace.

The estimation of the percentage of individual entities of shredded coated scrap having a height of less than or equal to 50 mm can be carried out on the whole of the scrap or on a part, typically on a number of individual entities at least equal to 20.

In the following, unless otherwise stated, the use of the expression “comprised between . . . and . . . ” may be replaced by the expression “comprised from . . . to . . . ”. In the following, unless otherwise stated, the expression like “the gain is comprised between A and B” means that the gain is comprised from A to B; the gain can take the value A or B; the limits A and B are included. Advantageously, at least 50% or 60% or 70% or 80% of the individual entities of the shredded coated scrap have a particle size comprised between 5 and 50 mm, preferably between 6 mm, or 7 mm or 8 mm or 10 mm, and 50 mm or 45 mm or 40 mm or 35 mm or 30 mm or 25 mm or 24 mm or 23 mm or 22 mm or 21 mm or 20 mm or 19 mm or 18 mm or 17 mm or 16 mm or 15 mm. Any combination of these values is advantageously possible.

The particle size of individual entities of the shredded coated scrap can be measured by sieving. To measure the particle size of individual entities of the shredded coated scrap, a series of sieves nested inside one another can be used. The dimensions of the sieve meshes decrease from top to bottom. The individual entities constituting the scrap are placed on the highest sieve and by vibration; the scraps are distributed on the different sieves according to their size. Square mesh sieves can be used through their opening; the nominal size of a sieve corresponds to the length of the side of the mesh (in mm). 10 sieves of size 60, 50, 40, 35, 25, 16, 8, 4, 2, 1 mm can be used. The sieving time is preferably at least 10 minutes. The inventors noted that the particle size of the individual entities of the coated scrap was not modified by the decoating operation. A particle size of the individual entities comprised between 5 and 50 mm allows an improvement in the submergence of the scrap in the liquid metal bath of the induction furnace.

The estimation of the percentage of individual entities of shredded coated scrap having a given particle size can be carried out on the whole of the scrap or on a part, typically on a number of individual entities at least equal to 20.

Advantageously, the volumetric mass of the coated scrap is comprised between 0.2 and 0.4 t/m³ (ton per cubic meter). The volumetric mass of the scrap is measured as follows: a cylindrical container with a capacity of 1 liter is filled with scrap, a vibration is produced in the form of small shocks so as to compact the scrap. The operation is repeated until the container is filled to the brim. The weight of the filled container from which the weight of the empty container is subtracted allows to determine the volumetric mass of the scrap.

The supply of shredded coated scrap having the geometric features as defined above can be obtained using a method comprising a grinding step using a knife mill, preferably equipped with a grid. In a knife mill, coated scrap is cut between knives mounted on a rapidly rotating shaft and a fixed row of knives. The presence of a grid ensures particle size control at the outlet of the mill. This step can be carried out separately on a dedicated tool. The advantage of the knife mill is to obtain clean cuts, to avoid deforming the scrap and for it to fold on itself.

The supply of shredded coated scrap having the geometric features as defined above can be obtained using a low density compaction method (used for the transport and handling of scrap to the recycling center), followed by a pre-grinder at low rotation speed allowing the release of unit UBCs from the compacted bales, followed by a mill allowing the clean cutting of the scrap (knife mill type). Compaction can be useful if scrap must be transported to the recycling center. However, care must be taken to ensure that compaction does not increase the apparent density of the compacted scraps, typically care must be taken to ensure that compaction does not increase the apparent density of the compacted scraps beyond a density of approximately 1400 kg/m³. This is called low density compaction. Indeed, if compaction is carried out too densely, it is not possible to individually release the constituent scraps of the compacted packages (also called bales or bundles). The inventors have noted that if it is not possible to grind the coated scraps individually with a knife mill, it would be necessary to aim for a particle size of less than 5 mm to obtain the desired fold ratio. This has the effect of increasing the metal loss at the time of re-melting.

Low speed pre-grinding, which can also be called “bale opener”, consists of bursting the bales without changing the shape of the compacted unit scraps. This step is of course optional if the scrap has not been compacted.

In order to guarantee a particle size comprised between 5 and 50 mm, preferably between 8 and 50 mm, a grid with a dimension of less than 50 mm, preferably less than 25 mm, can be used during the shredding operation. The inventors have found that the use of hammer mills is not advantageous for obtaining the desired geometries, in particular a fold ratio of less than or equal to 0.6 and a particle size comprised between 5 and 50 mm, and a height of less than or equal to 50 mm. Indeed, the scrap shredding operation carried out with a hammer mill tends to form scrap pellets which have a fold ratio greater than 0.6.

### 2/ Decoating Step

The shredded coated scrap thus supplied is then decoated. Decoating consists in heating the coated scrap to a temperature where humidity and organic materials (for example, paints, protective varnishes, lid seals and other smoke-producing materials) are eliminated, but without heating to too high temperature to prevent the metal from melting. Typically, the temperature is comprised between 450° C. and 540° C. The scrap is heated by thermal transfer with the atmosphere of the furnace, preferably by the heated gas resulting from the post-combustion of the fumes and which circulates in the decoating chamber. This operation allows on the one hand to dry the scrap and on the other hand to eliminate organic materials. Organic materials can be converted into CO₂ in a post-combustion unit to destroy organic molecules. Thus, a scrap that is dry, purified, and without smoke-producing materials is obtained.

After sufficient time has elapsed, the scrap is removed from the decoating chamber.

The decoating operation can also be obtained by chemical means: the shredded coated scrap can be immersed in different baths allowing the dissolution of the organic materials and followed by a drying operation.

The inventors have noted that the decoating or drying operation does not modify the fold ratio, the flatness or the shape of the scrap. The clean scrap therefore has the same fold ratio, the same flatness, the same particle size as the supplied shredded coated scrap. The volumetric mass of the clean scrap is slightly modified compared to that of the coated scrap and remains comprised between 0.2 and 0.4 t/m³.

The shredded coated scrap, before decoating, has an initial residual carbon amount typically of at least 1.5% by weight. Advantageously, the scrap, after the decoating step, has an amount of residual carbon less than 0.3% by weight, preferably less than 0.2% by weight, even more preferably less than 0.1% by weight. The amount of residual carbon in % by weight can be measured using a suitable instrument such as those supplied by the LECO company. The analysis consists of maintaining a given mass of scrap in a furnace after the decoating step at a temperature comprised between 250° C. to 550° C. under argon flow and converting the fumes into CO₂ in a catalysis furnace. The carbon measurement is evaluated by measuring the proportion of CO₂ via an infrared probe.

### 3/ Preparation of an Initial Liquid Metal Heel in an Induction Furnace

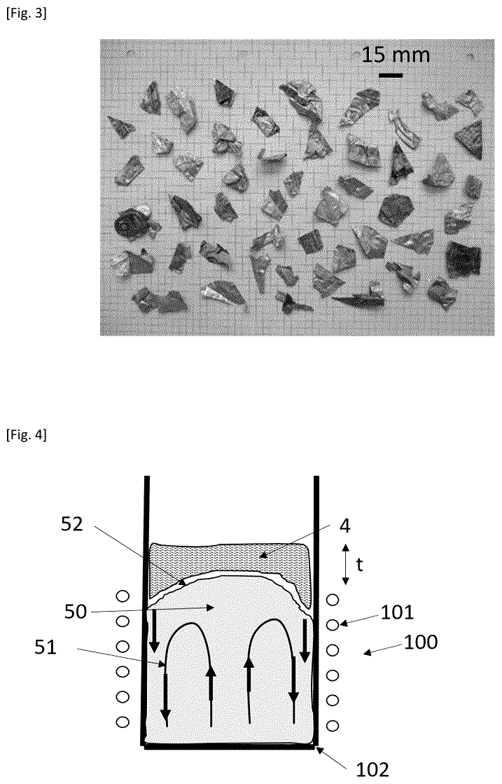

A crucible induction furnace 100 is provided (FIG. 4).

The crucible induction furnace essentially consists of one or two inductor coils cooled by circulation of heat transfer fluid 101, surrounding a rammed-earth refractory lining or a pre-fired refractory shell, forming the crucible 102 wherein the metal mass to be melted is placed.

A liquid metal heel 50 of a first composition into which the clean scrap obtained after decoating and/or drying will be poured, is prepared. The clean scrap obtained after decoating is poured onto the surface 52 of the liquid metal bath. The initial liquid metal heel can be obtained from clean scrap obtained after the decoating step or from massive waste, such as cutting scraps or cutting skeletons of thin or thick sheets, said massive waste being made of an alloy of composition compatible with the clean, and preferably purer scrap, whose composition will not harm the final composition. Typically, the massive waste is aluminum alloys of the 3XXX series, typically an AA3104 type alloy. The liquid metal heel can also be obtained by melting re-melted ingots of an alloy of 1xxx, 3xxx, 5xxx, 6xxx, 8xxx type compatible with clean scrap. In the case of successive castings, the liquid metal heel may advantageously consist of the remainder of the previous casting.

The volume of the heel represents approximately 30% to 60% of the total volume of the induction furnace, typically half of the capacity of the induction furnace. If the volume of the heel is too low, the risk is that the heel does not have sufficient thermal capacity to remain in the liquid state and solidifies in the furnace. Operation with a heel allows advantageous melting rates of 2 t/h to 4 t/h to be obtained.

4/ Step of Loading the Scraps Obtained after Step 3 and Melting

The step of loading the clean scrap, obtained after decoating and/or drying, consists of introducing the decoated scrap in the crucible induction furnace which previously contains a heel. No protective salt is used in the induction furnace. Advantageously, an inert gas, typically argon, is used to protect the liquid metal surface. The loading step is carried out continuously or semi-continuously. The scrap is loaded on the liquid metal heel by an appropriate means, for example a worm or a hopper or a vibrator system.

Advantageously, during the loading step, the scraps which are decoated, clean after decoating are loaded at a temperature above 100° C. for safety reasons in order to avoid any risk of explosion associated with the presence of residual humidity contained in the load. According to a preferred embodiment, to increase the melting rate and reduce energy consumption, the dried and decoated scraps are immediately loaded in the liquid metal after decoating, at a scrap temperature comprised between 200° C. and 450° C., preferably between 300° C. and 450° C., even more preferably between 400° C. and 450° C. In the case where the clean scrap is placed in the furnace at a temperature comprised between 300° C. and 450° C., it is advantageous for the residence time of the clean scrap above the liquid metal bath to be short in order to limit their oxidation.

The inventors have noted that it is advantageous for the bath to be covered by a floating decoated scrap bed 4 on the surface of the liquid bath 52 (FIG. 4) for most of the duration of step iv). The presence of a floating decoated scrap bed allows to protect the surface of the liquid metal bath from oxidation. Most of the duration of step iv) corresponds to a duration of at least 70% or 80% or 90% of the duration of step iv). The duration of step iv) is defined by the moment when the loading of the scraps is started and the end of loading. The end of loading being defined by the moment when the amount of molten metal in the induction furnace reaches its maximum filling level.

Advantageously, the thickness of the floating decoated scrap bed is at least 300 mm, advantageously 1000 mm (t, FIG. 4). The floating decoated scrap bed allows the continuous supply of the liquid metal bath until its complete dissolution. The inventors have found that it is advantageous that an individual entity of decoated scrap is kept on the surface of the liquid metal bath for a period of at most 2 min, preferably between 30 s and 90 s, in order to avoid its oxidation. It is therefore important to encourage their submergence in the liquid metal bath. Advantageously, the submergence of the scraps is improved by acting on the circulation speed field of the liquid metal bath so as to obtain a descending speed field 51 along the walls of the crucible (FIG. 4). This descending circulation speed field results from electromagnetic forces, called Laplace forces, well known in the design of crucible induction furnaces. The descending speed field along the walls of the crucible facilitates the submergence of individual entities of decoated scrap present in the floating decoated scrap bed. The inventors attribute the rapid submergence in the liquid metal bath to the particular shape of the individual entities used according to the invention. Indeed, due to their particle size and flatness, they are organized in the form of stacked strata, like stacked cards arranged parallel according to their largest face.

This effectively protects the liquid metal bath and facilitates the introduction of the individual entities into the liquid metal bath. Said individual entities slide over each other and plunge along the wall of the crucible.

By the presence of inductor coils 101 at the periphery of the crucible 102, it is possible to obtain a descending speed field 51, along the walls of the crucible allowing to improve the submergence of the scraps according to the invention. This descending speed field 51 creates a vortex which facilitates the immersion of the scraps.

Creating a vortex on the surface of the bath is not possible if a channel induction furnace is used. According to the inventors, a channel induction furnace does not allow to obtain favorable conditions for re-melting scraps according to the invention: the absence of vortices on the surface of the bath means that if the scraps according to the invention are introduced, they will stack on top of each other, make an insulating mattress and will not be immersed in the liquid metal bath. If the scraps are kept above the liquid metal bath for a long time, the scraps can oxidize and reduce the metal yield.

The descending speed field along the walls of the crucible is obtained by selecting the frequency of the induction furnace. Selecting a frequency between 50 Hz and 150 Hz, preferably around 60 Hz, allows to obtain a descending speed field. The inventors have found that this descending speed field induces the formation of a dome at the upper surface of the liquid metal bath. This dome shape allows to accelerate the submergence of the scrap in the liquid. It is also possible to act on the power of the furnace to modify the descending speed field. It is possible to adapt the frequency and/or power of the furnace according to the filling level of the furnace as magneto-hydrodynamic calculations can show. Stacking individual entities of decoated scrap associated with a descending speed field is particularly advantageous for the submergence of scrap in liquid metal. Advantageously, the power and frequency parameters of the furnace are adapted according to the thickness of the decoated scrap bed and the phase of the cycle (start, end of re-melting, temperature rise and hold).

The inventors noted that for a volumetric mass comprised between 0.2 and 0.4 t/m³, the scrap is quickly submerged in the liquid metal bath. This prevents oxidation of the scrap and maximizes the metal yield during melting.

The melting of the scraps allows to form a liquid metal bath of a second composition. The second composition is generally different from the first composition but could also be identical if the scrap has the same composition as the initial heel.

During the loading time and after complete re-melting of the scrap, the temperature of the liquid metal bath is less than or equal to 750° C., preferably less than or equal to 730° C.

The invention also relates to a method for manufacturing an intermediate product such as a rolling plate, a spinning billet, a forging block or an ingot or a sow wherein a step of casting the liquid metal obtained by the melting method according to the invention.

Advantageously, before the casting step, the metal is degassed and/or filtered and/or treated so as to remove any oxides possibly present and/or reduce the hydrogen content and/or eliminate any undesirable impurities.

### Example 1—Features of Shredded Coated Scrap

In this example, the coated scrap comes from used beverage cans (UBC). In this example, the grinding was carried out with a knife mill with a calibration grid of less than 40 mm. FIG. 3 shows the appearance of the scraps obtained in the knife mill which are representative of the scraps according to the invention. These scraps thus shredded are characterized in such a way as to determine the fold ratio (Table 2), their particle size by sieving (Table 2), the flatness of the scrap by measuring the height (Table 3), their apparent density (Table 1).

75% of the individual entities measured have a fold ratio of less than or equal to 0.6. 74% of the individual entities measured have a particle size comprised between 8 and 50 mm. 100% of the measured individual entities have a height of less than or equal to 15 mm.

TABLE 1
shredding Scrap according to the invention

| | |
|---|---|
| % of individual entities with a fold | 75% |
| ratio of less than or equal to 0.6 | |
| % of individual entities with a particle | 74% |
| size comprised between 8 and 50 mm | |
| % of individual entities with a height | 100% |
| of less than or equal to 15 mm | |
| Apparent density (t/m³) | 0.30 |

TABLE 2

| | Proportion per fold ratio | | | | |
|---|---|---|---|---|---|
| Fold ratio | 0-0.2 | 0.2-0.4 | 0.4-0.6 | 0.6-0.8 | 0.8-1 |
| % individual entity | 32% | 4% | 48% | 12% | 4% |
| (measured number 25) | | | | | |

TABLE 3

| | proportion per sieve range (mm) | | | | | | |
|---|---|---|---|---|---|---|---|
| Size | <1 | 1-2 | 2-4 | 4-8 | 8-16 | 16-25 | >25 |
| % individual | 0.4% | 0.9% | 4.0% | 20.4% | 70.8% | 3% | — |
| entity (measured | | | | | | | |
| number | | | | | | | |
| approximately | | | | | | | |
| 250) | | | | | | | |

TABLE 4

| | Proportion per height | | | | |
|---|---|---|---|---|---|
| height | 0-5 | 5-10 | 10-15 | 15-20 | >20 |
| % individual entity | 72% | 28% | 0% | 0% | 0% |
| (measured number 25) | | | | | |

### Example 2

The shredded coated scrap according to the invention characterized in the previous example was supplied and decoated in an IDEX type decoating furnace. The decoating was carried out at a loading rate of 500 kg/h, a furnace rotation speed of 1 rpm, and a smoke outlet temperature of 440° C. to 540° C. these conditions allowed to obtain a residual carbon varying from 0.1%-0.2%. After decoating, the decoated scrap was introduced into a crucible induction furnace previously filled with a liquid heel. The initial heel was made from 3104 scrap, its volume is approximately 40% of the maximum capacity of the crucible. No protective salt was used. The decoated scrap was introduced into the furnace at a temperature above 100° C., typically at a temperature of 200° C. The frequency of the furnace was set at 62 Hz. The power of the furnace was set at the start of the cycle at 50%. Selecting a frequency close to 60 Hz accelerates the submergence of the shredded material in the liquid. A decoated scrap mattress was maintained on the surface of the liquid bath in order to reduce air penetration and protect the surface of the bath against oxidation. Argon blowing was also carried out to reinforce the protection of the metal. Loading the decoated scrap is carried out at a rate of approximately 4000 kg/h. Taking into account the oxidation kinetics of the alloy in the temperature range measured in the mattress (220° C. to 250° C.), the decoated scrap does not have time to oxidize on the surface of the bath. It stays therein no longer than 1 minute. The geometry of the individual entities of the scrap and their organization in strata facilitates their flow on the surface of the bath as well as along the crucible.

A net metal yield of 97.8% could be obtained using the method according to the invention. In particular, the net yield on the element Mg is 94%. The inventors believe that this excellent performance is made possible by the choice of the geometry of the individual entities of the shredded coated scrap, in particular the fold ratio, the particle size and the flatness.

### Example 3—Reference

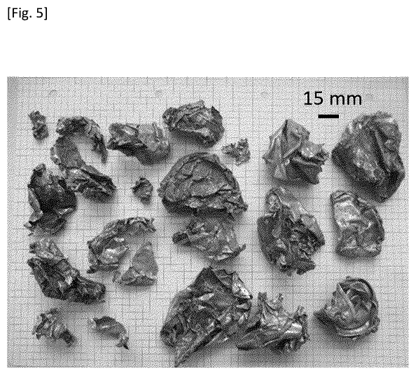

For comparison, the fold ratio obtained on shredded coated scrap obtained by hammer mill (see FIG. 5) was determined according to the same principle as that described in Example 1.

The fold ratio was measured on 25 samples. It is thus observed that the shredded scraps obtained by hammer mill do not allow to obtain a fold ratio <0.6 (see table 5): 100% of the scrap have a fold ratio greater than 0.6.

The inventors consider that this is related to the fact that shredding with knives allows for a sharper cut and therefore prevents the scraps from folding on themselves.

TABLE 5

| | Proportion per fold ratio | | | | |
|---|---|---|---|---|---|
| Fold ratio | 0-0.2 | 0.2-0.4 | 0.4-0.6 | 0.6-0.8 | 0.8-1 |
| % individual entity | 0 | 0 | 0 | 68% | 32% |
| (measured number 25) | | | | | |

The particle size was measured in the same way as previously: it can be seen that most of the scrap obtained with a hammer mill does not allow to predominantly obtain a particle size comprised between 8 and 16 mm (see table 6).

TABLE 6

| | proportion per sieve range (mm) | | | | | | |
|---|---|---|---|---|---|---|---|
| Size | <1 | 1-2 | 2-4 | 4-8 | 8-16 | 16-25 | >25 |
| % individual | 0.5% | 0.8% | 2.3% | 7.9% | 19.8% | 18.8% | 50% |
| entity (measured | | | | | | | |
| number | | | | | | | |
| approximately | | | | | | | |
| 250) | | | | | | | |

1. A method for re-melting coated aluminum alloy scrap comprising the following steps:
(i) aluminum alloy shredded coated scrap, consisting of individual entities, is supplied,
(ii) decoating of said shredded coated scrap is carried out to obtain decoated scrap,
(iii) an initial liquid metal heel of a first composition is prepared in a crucible induction furnace operating at a given frequency,
(iv) the decoated scrap is loaded into the induction furnace directly on the initial heel in order to be melted,
characterized in that
at least 50% of the individual entities of the shredded coated scrap supplied in step i) has a fold ratio (R) of less than or equal to 0.6,
wherein the fold ratio (R) of an individual entity is defined by
$$fold ratio = R = \frac{unfolded area - folded area}{unfolded area}$$
wherein the folded area is the maximum area of the orthogonal projection of the individual entity onto a plane and the unfolded area is the total area of the same individual entity after it has been unfolded

2. The scrap re-melting method according to claim 1 characterized in that the shredded coated scrap supplied in step i) is obtained using a method comprising a shredding step using a knife mill, optionally equipped with a grid configured to adjust a particle size.

3. The scrap re-melting method according to claim 1 characterized in that at least 50% of the individual entities of the shredded coated scrap supplied in step i) has a particle size comprised between 5 and 50 mm, preferably between 8 and 50 mm, more preferably between 8 and 25 mm, more preferably between 8 and 16 mm, the particle size being measured by sieving.

4. The scrap re-melting method according to claim 1 characterized in that at least 50% of the individual entities of the shredded coated scrap supplied in step i) has a height of less than or equal to 50 mm, preferably less than or equal to 30 mm, even more preferably less than or equal to 15 mm.

5. The method for re-melting coated aluminum scrap according to claim 1, characterized in that the volumetric mass of the shredded coated scrap supplied in step i) is comprised between 0.2 and 0.4 t/m³.

6. The method for re-melting coated scrap according to claim 1 characterized in that the coated scrap supplied in step i) is obtained from scrap recovered from aluminum household packaging, typically used aluminum beverage cans.

7. The method for re-melting coated scrap according to claim 1, characterized in that the decoated scrap obtained after step ii) is introduced into the induction furnace in step iv) at a temperature above 100° C., preferably at a temperature comprised between 200° C. and 450° C., more preferably between 300° C. and 450° C., even more preferably between 400° C. and 450° C.

8. The scrap re-melting method according to claim 1 characterized in that no protective salt is used in the induction furnace.

9. The method for re-melting coated scrap according to claim 1, characterized in that during step iv) a floating decoated scrap bed is maintained on the surface of the liquid bath for most of the duration of step iv).

10. The method for re-melting coated scrap according to claim 1 characterized in that the frequency of the induction furnace during step iv) is comprised between 50 Hz- and 150 Hz.

11. The scrap re-melting method according to claim 1 characterized in that the loading in step iv) is carried out discontinuously or continuously, preferably using a worm or a hopper or a vibrator system.

12. The method for re-melting coated scrap according to claim 1 characterized in that the temperature of the liquid metal bath during step iv) is less than or equal to 750° C., preferably less than or equal to 730° C.

13. The scrap re-melting method according to claim 1 characterized in that during step iv) the liquid metal bath is inert, typically using a flow of argon gas.
